(19) United States
(12) Patent Application Publication
(10) Pub. No.: US 2020/0393417 A1
(43) Pub. Date: Dec. 17, 2020

(54) NORMAL BEAM EMAT ON COMPONENTS WITH A BONDED MAGNETOSTRICTIVE LAYER

(71) Applicant: Borja Lopez Jauregui, Lynchburg, VA (US)

(72) Inventor: Borja Lopez Jauregui, Lynchburg, VA (US)

(21) Appl. No.: 16/439,522

(22) Filed: Jun. 12, 2019

(51) Int. Cl. G01N 29/24; G01N 29/04; G01N 29/34

(52) U.S. Cl. CPC G01N 29/2412; G01N 29/34; G01N 29/043

(57) ABSTRACT

An EMAT ultrasonic system for non-destructive testing that comprises a layer of magnetostrictive material with low magnetocrystalline anisotropy bonded to the surface of the component where the ultrasound is being generated, an EMAT transducer capable of radiating a shear horizontal wave orthogonally to the entry plane on this magnetostrictive layer, and an instrument connected to the transducer capable of transmitting and receiving EMAT signals and provide measurements of time, amplitude and frequency response. The transducer is designed to generate shear horizontal waves that radiate normal to the surface, and can be deployed as a single element or in phased array. The transducer can work in either pulse-echo (same transmitter and receiver) or pitch-catch (different transmitter and receiver).

### BACKGROUND OF THE INVENTION

The present invention relates generally to the field of non-destructive testing, and in particular to ultrasonic inspection with normal beam EMAT transducers for measurement and detection purposes.

Ultrasonic transducers designed to radiate waves normal to the face of the transducer are commonly referred to as normal beam, and they are widely used for applications that require inspection and measurement directly under the transducer such as; measurement of thickness and elongation, detection of corrosion and erosion, detection of internal flaws, and measurement of material properties.

With regards to the transduction mechanism, ultrasonic waves are often generated with a piezoelectric transducer, which requires coupling the energy produced into the component using pressure or a coupling medium like glue or a liquid that can sustain the transfer of ultrasound from the transducer into the component. Ultrasonic waves can also be generated on the surface of the component itself using lasers, or through electromagnetic induction using an Electromagnetic Acoustic Transducer (EMAT).

An EMAT induces ultrasonic waves into a component with two interacting magnetic fields. A relatively high frequency (RF) alternating field generated by electrical coils interacts with a low frequency or static field generated by magnets to generate a Lorentz force in a manner similar to an electric motor. The disturbance from the two forces created on the surface lattice of the material produces an elastic wave that travels through the component. In a reciprocal process, the interaction of elastic waves in the presence of a magnetic field induces currents in the receiving EMAT coil circuit. In ferromagnetic materials, magnetostriction produces additional stresses that can increase the signals to much higher levels than what can be obtained by the Lorentz force alone.

Adhering a layer of magnetostrictive material to the surface of a component to enhance the generation of ultrasound with EMAT transducers is well known for guided wave inspections where the waves travel parallel to the entry plane from the point where the ultrasound has been generated. Guided waves follow the boundaries of the structure where they are generated, and while they are very useful to cover long expanses of material with fewer transducers or to inspect inaccessible areas, they are not suited to provide accurate measurements and detection directly under the transducer.

The novelty of this invention stems from the use of a layer of magnetostrictive material that is bonded to the surface of a component in a way that exhibits low magnetocrystalline anisotropy, so as to allow the generation of normal beam waves in the component using shear horizontal EMAT transducers. The addition of this layer makes any component suitable for normal beam EMAT inspection, and greatly increases signal-to-noise of the received signal.

### SUMMARY OF THE INVENTION

The present disclosure relates to an ultrasonic non-destructive testing system using normal beam EMAT transducers that radiate shear horizontal ultrasonic waves orthogonally to the plane of entry. These ultrasonic waves are generated in a component in which a layer of magnetostrictive material with low magnetocrystalline anisotropy has been bonded onto its surface.

The system uses a standard ultrasonic instrument to generate and read the ultrasonic signals from said EMAT transducers.

The addition of the magnetostrictive material bonded to its surface makes any component highly responsive to generation and reception of ultrasound with EMAT, and greatly increases signal to noise when compared to a component that does not have the magnetostrictive layer.

This magnetostrictive layer has been added to the component in a way that exhibits low magnetocrystalline anisotropy so its crystalline structure can be properly biased by the magnet or magnets in the EMAT transducer used to generate normal beam shear horizontal waves.

The present disclosure provides different constructions of shear horizontal EMAT transducers designed to generate a normal beam wave in the magnetostrictive layer. In all these constructions the EMAT transducer includes one or several magnets to provide the biasing magnetic field in the magnetostrictive material, and one or more RF coils to generate the eddy currents in the surface of said magnetostrictive material.

### BRIEF DESCRIPTION OF THE DRAWINGS

FIG. 1 shows a construction for a normal beam shear horizontal wave EMAT transducer. A magnetostrictive layer without magnetic bias (1) has been bonded to a component (2). The normal beam single pole magnet (3) covers the full RF coil (4), which is shaped as a standard racetrack or spiral EMAT coil. The static magnetic field and the dynamic field generate normal beam shear waves under each side of the RF coil in the magnetostrictive layer. The shear waves (5) on one half move left to right while the other half moves right to left as they travel down the component corresponding to the different sign of the current in the RF coil.

FIG. 2 shows another construction for a normal beam shear horizontal wave EMAT transducer. A magnetostrictive layer (1) without magnetic bias has been bonded to a component (2). The normal beam single pole magnet (3) covers the center of the RF coil (4), which is shaped as a standard butterfly EMAT coil. The static magnetic field and the dynamic field generate normal beam shear waves under each side of the RF coil in the magnetostrictive layer. The shear waves (5) all have the same motion (left to right or right to left, depending on the sign of the current) as they travel down the component.

FIG. 3 shows another construction for a normal beam shear horizontal wave EMAT transducer. A magnetostrictive layer without magnetic bias (1) has been bonded to a component (2). Each side of the two magnet array with opposing poles (3) covers one side of the RF coil (4), which is shaped as a standard racetrack coil. The static magnetic field and the dynamic field generate normal beam shear waves (5) under each side of the RF coil in the magnetostrictive layer. Both sides move in the same direction since the polarity of the magnetic field is inverted for the opposite sign of the RF coil.

FIG. 4 shows another construction for a normal beam shear horizontal wave EMAT transducer. A magnetostrictive layer without magnetic bias (1) has been bonded to a component (2). An RF coil (4) shaped as a spiral, racetrack or butterfly is located between two magnets (3) that provide a tangential field. The construction generates shear waves (5) with different motions (left to right or right to left) depending on the current sign of the RF coil wires between the poles.

FIG. 5 shows a construction for an 8 channel normal beam shear horizontal wave EMAT transducer in phased array configuration. A magnetostrictive layer without magnetic bias (1) has been bonded to a component (2). The normal beam single pole magnet (3) covers the full RF coil (4-1 to 4-8). The RF coil has 8 independent channels connected to two wires each for a total of 16 wires. The construction generates shear waves (5) on each channel. Each channel is timed to electronically steer the beam from side to side and/or to focus at different depths in standard phased array fashion. The number of channels and wires per channel can be decreased or increased to achieve different levels of signal strength and resolution.

### DETAILED DESCRIPTION OF THE INVENTION

EMAT has important advantages for normal beam inspection that derive from its ability to generate ultrasound in the material inspected.

One of the advantages is the ability to perform non-contact inspections without having to physically couple the transducer with the component using pressure, adhesives or liquid couplant, thus permitting inspections of very hot and very cold materials without risking the integrity of the transducer or contaminating the component. The lack of coupling medium also increases the accuracy of the measurement which can be very relevant for high-precision thickness and elongation measurements. Another advantage is the ability to generate sound normal to the entry plane of the component even when the transducer itself is at an angle with regards to this entry plane. Another advantage is the imperviousness to roughness and other surface conditions that can affect the transfer of sound into the component when generated from the outside (as with a piezoelectric transducer). Another advantage is the ability to generate shear wave energy directly into the component without having to physically bond the transducer to the material, or using a very viscous coupling medium that can sustain the transmission of shear energy.

The main disadvantage of EMAT is that it only generates ultrasound on conductive materials that sustain the generation of eddy currents on its surface. Another important disadvantage is the inefficiency of the transduction process in most materials, which is typically compensated by using very high power pulsers that consume a lot of energy which is mostly wasted as heat.

The addition of especially treated magnetostrictive strips adhered to a component to enhance the EMAT signals for guided wave inspections has been documented since the 1980s. These strips typically use Ni, FeNi and FeCo alloys that are heat and magnetically treated to create a biased field in their microcrystalline structure that promotes the generation of the guided wave mode of interest (typically torsional waves). Prior art includes many applications that use adhered and pressure coupled strips to perform inspections on pipes, rods, and different structures using guided waves. The strips are not used for normal beam inspection with EMAT since the biased field doesn't provide any advantage, and often precludes the generation of normal beam energy in the component. Even without post-rolling heat and magnetic treatments, the rolling process used in the creation of the strip can impart magnetic anisotropy that can reduce or nullify its value for normal beam EMAT applications.

A more recent innovation by Chehaibou et al, as described in WO2012013900A1, introduces the coating of a component with magnetostrictive material using cold spray, thermal spray, laser or heat treatment methods that provide a metallurgic, permanent bond between the magnetostrictive material and the component to generate guided waves. Chehaibou's invention describes different bonding methods and specific coating patterns to perform guided wave inspections. The inventor also claims a method of incorporating a magnetic field during the deposition of the magnetostrictive material to create a magnetic bias and potentially enhance its performance for guided wave inspection.

This disclosed invention on the other hand relates to a system for the generation of normal beam with EMAT in which it is required to have an unbiased, magnetically anisotropic magnetostrictive layer of material to generate the ultrasound. Having low magnetocrystalline anisotropy is key, since the magnetic bias can conflict with the magnetic field from the normal beam EMAT transducer, and reduce or negate any gains from the use of the magnetostrictive material.

Thermal spray—including cold spray- and laser deposition processes are inherently anisotropic, and as such are very well suited for adding the magnetostrictive material on the component, but this bonding can be also performed with heat treatment methods as long as the material shows low magnetocrystalline anisotropy once deposited, so it can be biased with the transducer magnet or magnets. The application of a layer in such manner permits using standard construction normal beam EMAT transducers and overcome their disadvantages. On one hand, bonding a magnetostrictive layer to its surface will make any component, conductive or not, receptive to EMAT. On another hand, the application of a magnetostrictive layer can help overcome the inefficiency of EMAT on many components. As an example, the addition of a 0.010″ layer of pure Nickel using cold spray to a carbon steel plate can enhance signal to noise by over 60dB, which is equivalent to a thousand fold increase in signal amplitude when compared to the same material without the coating. From the perspective of power consumption, the magnetostrictive coating would reduce power requirements by an equivalent amount, which could make EMAT an ideal solution for permanently installed sensors used in monitoring applications where low power consumption and inexpensive constructions are paramount.

This invention can be applied to all normal beam applications including but not limited to the measurement of wall thickness, measurement of corrosion and erosion, detection of cracks and flaws, measurement of bolt and rod elongation, and weld inspection.

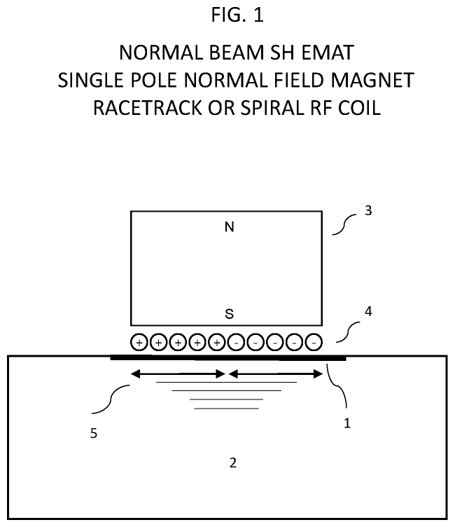

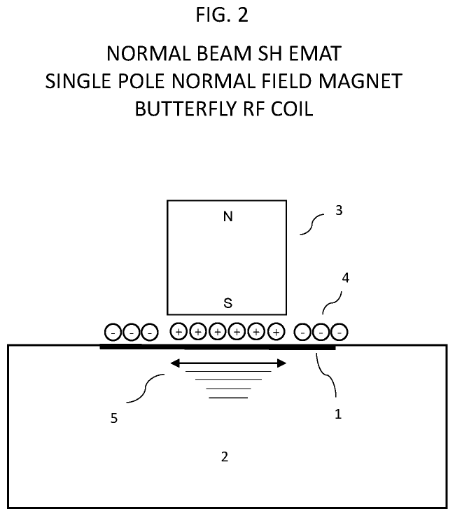

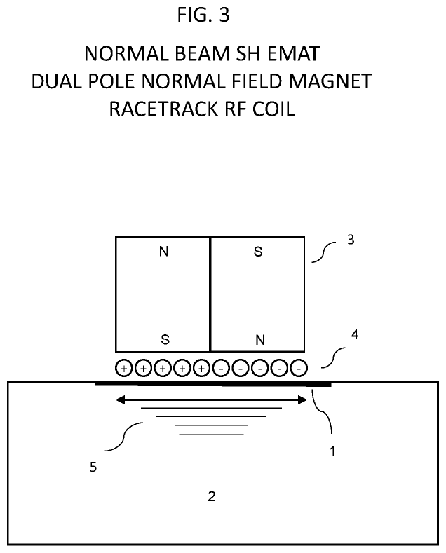

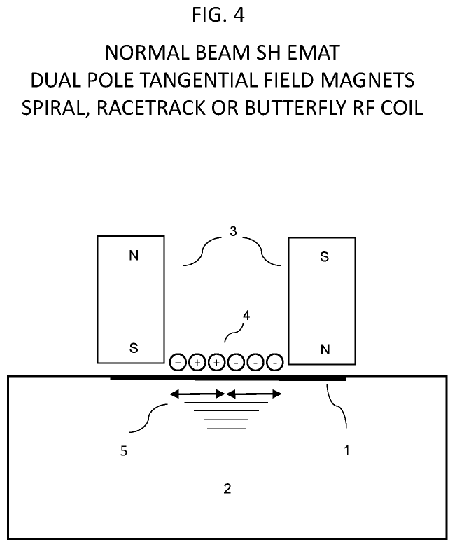

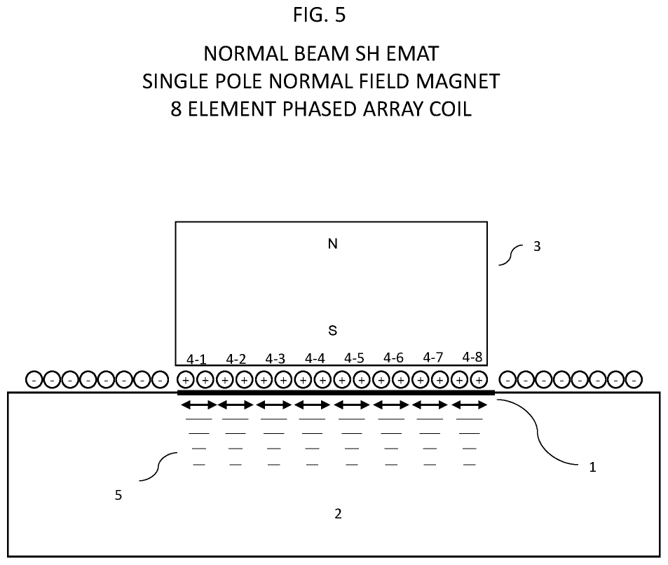

The construction of shear horizontal EMAT transducers for inspection of components with magnetostrictive material bonded to its surface is the same that is used for materials without this layer, and can include mono element or multi-element transducers for phased array applications. FIGS. 1 to 5 show standard constructions for shear wave transducers. It should be understood, of course, that the foregoing relates to exemplary embodiments of the invention and that modifications may be made without departing from the spirit and scope of the invention as set forth in the following claims.

What is claimed is:

1. An ultrasonic system for non-destructive testing comprising:
a layer of magnetostrictive material bonded to the surface of a component;
an EMAT transducer comprising one or more RF coils and one or more magnets that generate ultrasound in the layer of magnetostrictive material;
an instrument capable of pulsing and receiving signals from said EMAT transducer and provide measurements of time, signal amplitude, and frequency response.

2. The layer of magnetostrictive material according to claim 1, wherein said layer is composed of materials that exhibit magnetostriction such as Nickel, Cobalt, alloys of FeCo, alloys of FeNi, alloys of FeAl, alloys of FeGa, Terfenol-D.

3. The layer of magnetostrictive material according to claim 1, wherein said layer has been added in a way that exhibits low magnetocrystalline anisotropy.

4. The layer of magnetostrictive material according to claim 1, wherein said layer has been added to the surface of the component using a thermal spray process.

5. The layer of magnetostrictive material according to claim 1, wherein said layer has been added to the surface of the component using a cold spray process.

6. The layer of magnetostrictive material according to claim 1, wherein said layer has been added to the surface of the component using a laser.

7. The layer of magnetostrictive material according to claim 1, wherein said layer has been added to the surface of the component using a heat treatment method.

8. The EMAT transducer according to claim 1, wherein said transducer is designed to radiate shear horizontal ultrasonic waves orthogonally to the entry plane.

9. The EMAT transducer according to claim 9, wherein the RF coil and magnet or magnets work as a single element.

10. The EMAT transducer according to claim 9, wherein the RF coils and magnet or magnets work in phased array.

11. The EMAT transducer according to claim 9, wherein the same RF coil or coils are used for transmission and reception.

12. The EMAT transducer according to claim of claim 9, wherein different RF coil or coils are used for transmission and reception.
